(19) United States
(12) Patent Application Publication
(10) Pub. No.: US 2012/0326014 A1
(43) Pub. Date: Dec. 27, 2012

(54) OPTICAL FIBER CONNECTOR ASSEMBLY

(75) Inventors: KAI-WEN WU, Tu-Cheng (TW); YI-ZHONG SHEU, Tu-Cheng (TW)

(73) Assignee: HON HAI PRECISION INDUSTRY CO., LTD., Tu-Cheng (TW)

(21) Appl. No.: 13/470,373

(22) Filed: May 14, 2012

(30) Foreign Application Priority Data
Jun. 22, 2011 (TW) 100121828

(51) Int. Cl. G01J 1/42

(52) U.S. Cl. 250/216

(57) ABSTRACT

An optical fiber connector assembly includes an optical socket and an optical plug. The optical socket defines a recess, and a coupling surface in the recess, with light emitters and light detectors on the coupling surface. Each light emitter includes a light emitting surface exposed in the recess, and is configured for converting a first electrical signal into a first optical signal. Each light detector includes a light incident surface exposed in the recess, and is configured for converting a second optical signal into a second electrical signal. The optical plug can be inserted into the recess, and includes optical output fibers aligned with the light emitting surface for outputting the first optical signal from the light emitting surface, and optical input fibers aligned with the light incident surface for inputting the second optical signal to the light incident surface.

### BACKGROUND

1. Technical Field

The present disclosure relates to an optical fiber connector assembly.

2. Description of Related Art

An optical fiber connector assembly may include optical fibers and two connectors, such as male and female, for coupling the optical fibers together to allow light transmittance between the optical fibers. The connectors include lenses aligned with an optical fiber. When coupling connectors together, a lens in the male connector has to be precisely aligned with a corresponding lens in the female connector to ensure optimum light transmittance. However, the alignment of lenses is difficult to achieve constantly, which may result in poor light transmittance.

Therefore, an optical fiber connector assembly and an optical socket, which can overcome the above-mentioned problems, are needed.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and schematic view of an optical fiber connector assembly, according to an embodiment, the optical fiber connector assembly including an optical socket.

FIG. 2 is a sectional view taken along line II-II of the optical fiber connector assembly of FIG. 1, showing the optical fiber connector assembly coupled together.

FIG. 3 is similar to FIG. 2, but showing the optical fiber connector assembly uncoupled.

FIG. 4 is an isometric and schematic view of an electronic device including the optical socket of FIG. 1.

FIG. 5 is a partial front view of the electronic device of FIG. 4.

### DETAILED DESCRIPTION

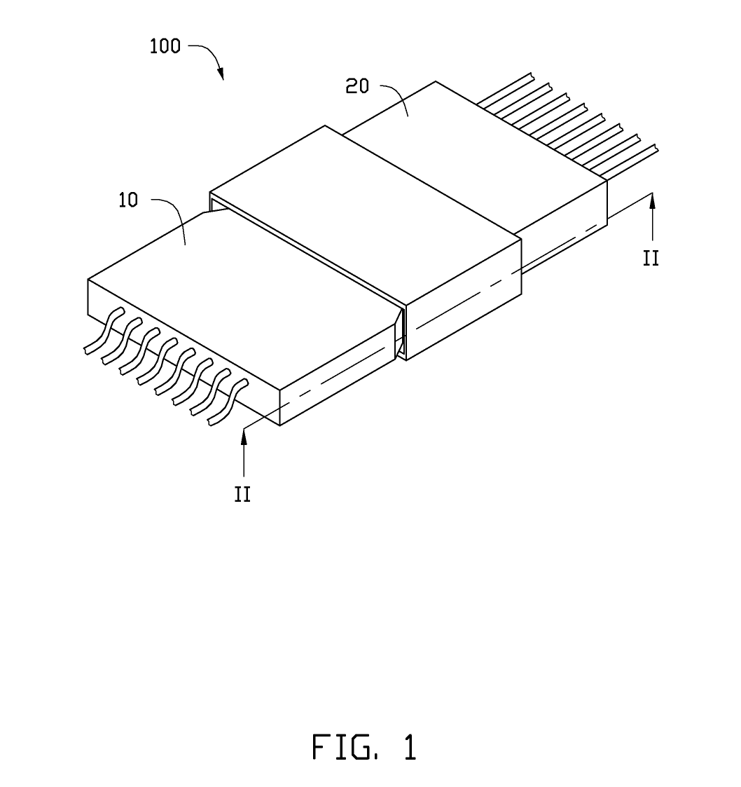

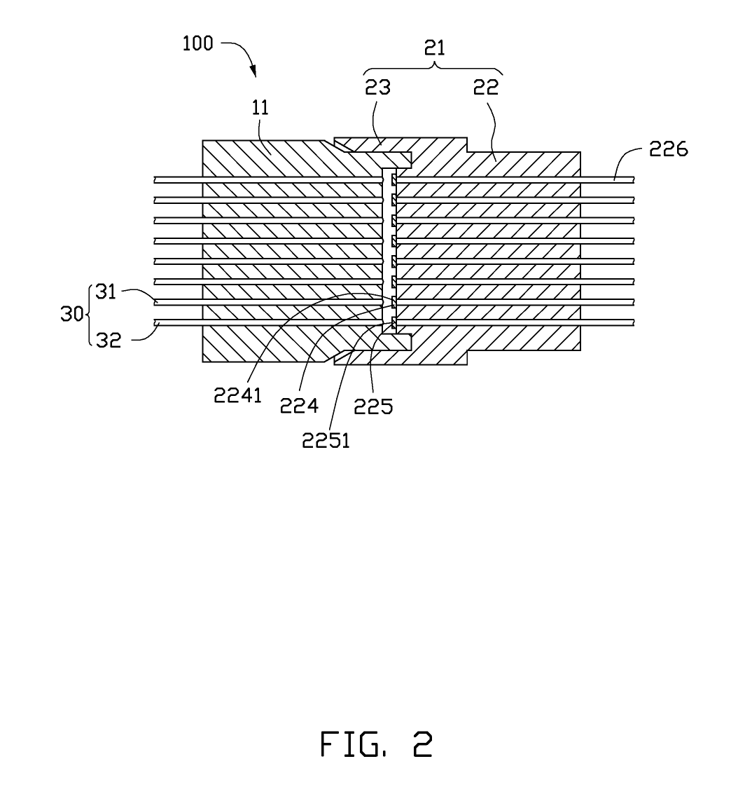

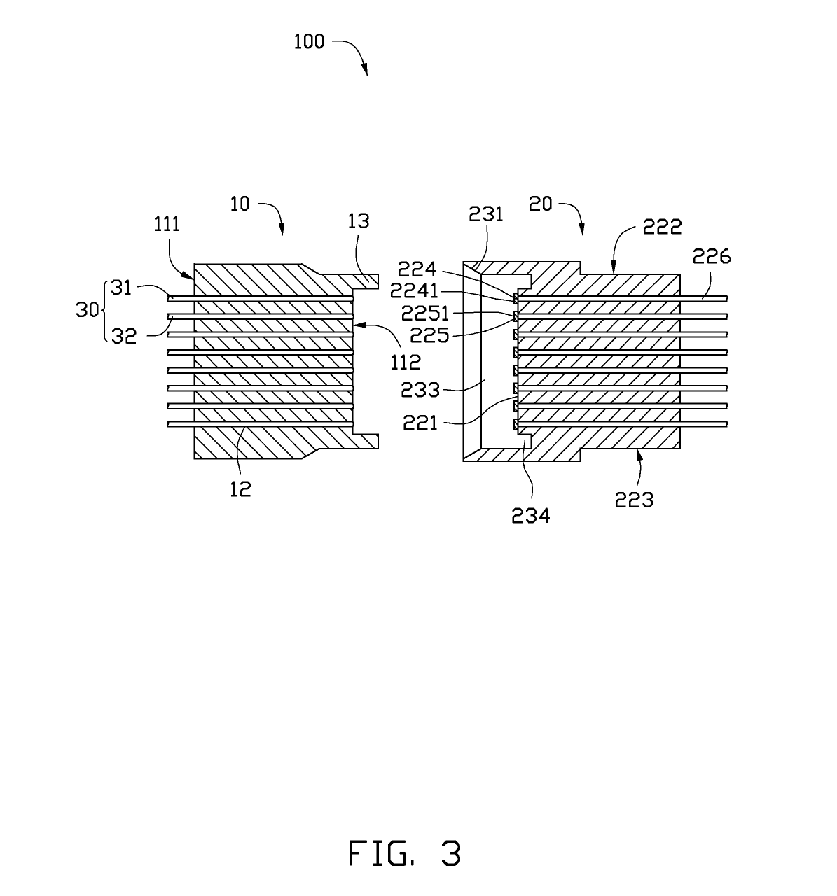

Referring to FIGS. 1 to 3, an optical fiber connector assembly 100, according to an embodiment, includes an optical plug 10 and an optical socket 20. The optical plug 10 couples with the optical socket 20 for signal transmission.

The optical plug 10 includes a substantially cuboid first body 11. The first body 11 includes a first end surface 111 and an opposite second end surface 112. The first body 11 defines a number of through holes 12 extending from the first end surface 111 to the second end surface 112. The through holes 12 are substantially parallel to each other. Each though hole 12 receives an optical fiber 30. Therefore, the optical fibers 30 are parallel to each other in the through holes 12.

The optical fibers 30 interactively transmit signals to/from the optical socket 20. The optical fibers 30 include a number of output fibers 31 and a number of input fibers 32. Each of the output fibers 31 transmits signals from the optical socket 20 to the optical plug 10. Each of the input fibers 32 transmits signals from the optical plug 10 to the optical socket 20. In this embodiment, the optical fibers 30 are lensed optical fibers.

The first body 11 further includes positioning rods 13 abutting the second end surface 112. The positioning rods 13 are used for positioning the optical plug 10 in place with respect to the optical socket 20.

The optical socket 20 includes a substantially cuboid second body 21. The second body 21 includes a conversion portion 22 and a coupling portion 23 integrally formed with the conversion portion 22. The coupling portion 23 defines a recess 233 for insertion of the optical plug 10.

The conversion portion 22 includes a coupling surface 221, a first side surface 222, and a second side surface 223. The coupling surface 221 is positioned in the recess 233. The first and second side surfaces 222, 223 are opposite to each other and are adjacent to the coupling surface 221. The conversion portion 22 further includes a number of light emitters 224 and a number of light detectors 225. The light emitter 224 is configured for receiving electrical signals, converting the electrical signals into optical signals, and outputting the optical signals to an output fiber 31. The light detector 225 is configured for receiving optical signals from an input fiber 32, converting the optical signals into electrical signals, and outputting the electrical signals.

The light emitter 224 includes a light emitting surface 2241. The light emitting surface 2241 faces out from the recess 233 and is exposed in the recess 233. The light emitting surface 2241 is aligned with an output fiber 31 of the optical plug 10. The light emitter 224 sends the optical signals to the output fiber 31 through the light emitting surface 2241.

The light detector 225 includes a light incident surface 2251. The light incident surface 2251 faces out from the recess 233 and is exposed in the recess 233. The light incident surface 2251 is aligned with an input fiber 32. The light detector 225 receives the optical signals from the input fiber 32 through the light incident surface 2251.

In this embodiment, the light emitter 224 is a vertical-cavity surface-emitting laser (VCSEL), and the light detector 225 is a photo-diode.

The conversion portion 22 further includes a number of electric wires 226. The electric wires 226 are electrically connected to the light emitters 224 and the light detectors 225 for transmitting electrical signals.

The coupling portion 23 includes a coupling sleeve 231 which is rectangular in section. The outline of the coupling sleeve 231 is substantially cuboid. The coupling sleeve 231 defines the recess 233. The coupling portion 23 further defines positioning holes 234 in the coupling surface 221. The positioning holes 234 communicate with the recess 233 and are aligned with the positioning rods 13 of the optical plug 10. When the optical plug 10 is inserted into the recess 233, the positioning rods 13 lock into the positioning holes 234 for firmly connecting the optical plug 10 to the optical socket 20.

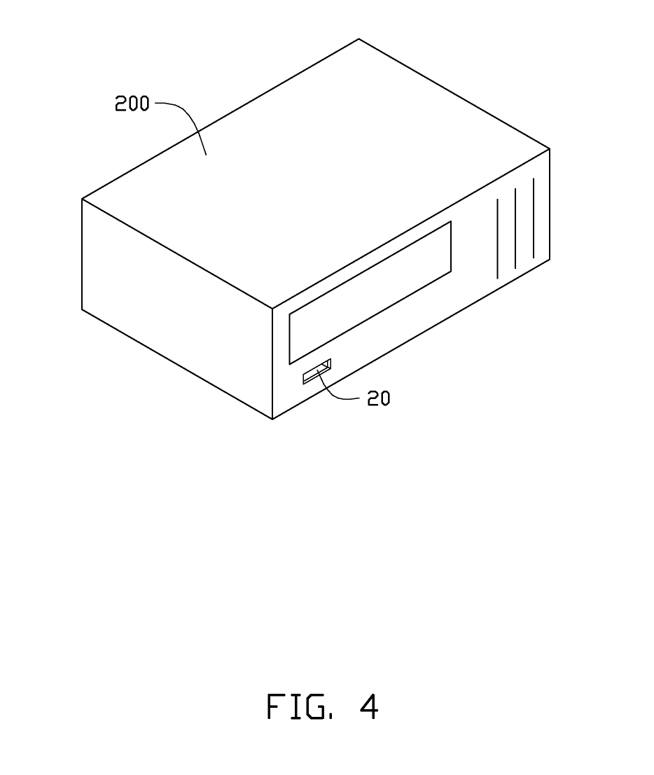

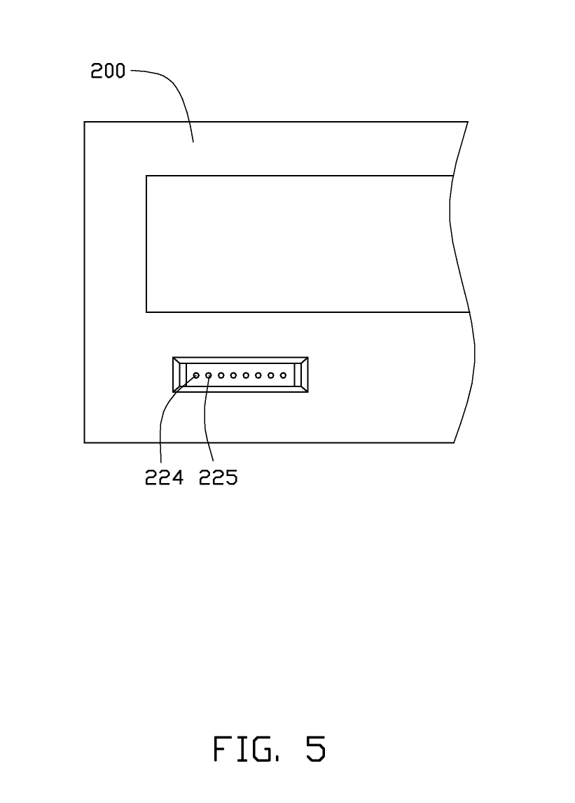

Referring to FIGS. 4 and 5, when in use, the optical socket 20 is set on an electronic device 200 and the electrical wires 226 are electrically connected to inner circuit (not shown) of the electronic device 200. The optical plug 10 is inserted into the optical socket 20. The electronic device 200 can exchange signals with outside through the optical fiber connector assembly 100.

It is the light emitter 224 and the light detector 225 which are respectively used for aligning with the optical fibers 30, thus, the alignment of the lenses in the optical plug 10 with the lenses in the optical socket 20 is not needed. Therefore, losses in the transmitted and received signals can be minimized.

The above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An optical fiber connector assembly, comprising:
an optical socket defining a recess, and comprising a coupling surface in the recess, the optical socket comprising at least one light emitter and at least one light detector positioned on the coupling surface, wherein each of the at least one light emitter comprises a light emitting surface exposed in the recess, and is configured for converting a first electrical signal into a first optical signal, and each of the at least one light detector comprises a light incident surface exposed in the recess, and is configured for converting a second optical signal into a second electrical signal; and
an optical plug capable of inserting into the recess, and comprising at least one optical output fiber aligned with the light emitting surface of the at least one light emitter for outputting the first optical signal from the light emitting surface, and at least one optical input fiber aligned with the light incident surface of the light detector for inputting the second optical fiber to the light incident surface.

2. The optical fiber connector assembly of claim 1, wherein the at least one light emitter is a vertical-cavity surface-emitting laser.

3. The optical fiber connector assembly of claim 2, wherein the at least one optical output fiber and the at least one optical input fiber are lensed optical fibers.

4. The optical fiber connector assembly of claim 1, wherein the at least one light detector is a photo diode.

5. The optical fiber connector assembly of claim 1, wherein the optical plug further comprises positioning rods, the optical socket further comprises positioning holes, and the positioning rods lock into the positioning holes when the optical plug is inserted into the recess.

6. An optical socket, comprising:
a body defining a recess for receiving an optical plug, and comprising a coupling surface in the recess; and
at least one light emitter and at least one light detector positioned on the coupling surface, wherein each of the at least one light emitter comprises a light emitting surface exposed in the recess, and is configured for converting a first electrical signal into a first optical signal and sending the first optical signal to the light emitting surface, and each of the at least one light detector comprises a light incident surface exposed in the recess, and is configured for receiving a second optical signal from the light incident surface and converting the second optical signal into a second electrical signal.

7. The optical socket of claim 6, wherein the at least one light emitter is a vertical-cavity surface-emitting laser.

8. The optical socket of claim 6, wherein the at least one light detector is a photo diode.

9. The optical socket of claim 6, further defining positioning holes for engaging with positioning rods of the optical plug.
